(19) United States
(12) Patent Application Publication
(10) Pub. No.: US 2006/0278075 A1
(43) Pub. Date: Dec. 14, 2006

(54) Air purifier and related methods for residential dwellings

(76) Inventor: Ivar Blackner, Salt Lake City, UT (US)

Correspondence Address: Lynn G. Foster, 602 East 300 South, Salt Lake City, UT, 84102, US

(21) Appl. No.: 11/152,261

(22) Filed: Jun. 13, 2005

(51) Int. Cl. B03C 3/016

(52) U.S. Cl. 95/57; 96/16; 96/224; 422/24; 422/121

(57) ABSTRACT

Cost-effective and efficient filtration technology is disclosed by which airborne pollution and contaminants are significantly removed from air circulated through furnaces and/or air conditioning systems in residential dwellings. Filters comprising both an anti-microbial ultra-violet lamp, for irradiation of airborne viruses and bacteria, and an electrostatic filter pad for trapping and holding other airborne particles are disclosed.

### FIELD OF THE INVENTION

The present invention relates generally to the field of reduction in airborne pollution and contaminates in residential dwellings and, more particularly, to a cost-effective air filtration system by which airborne particles, infection-causing microbes and allergy-triggering substances are greatly reduced if not eliminated by concurrent ultra violet radiation and electrostatic filtration of displaced air for the improved health and well-being of the occupants of the residential dwellings.

### BACKGROUND

It has been estimated that the air quality inside the typical residential dwelling may be from five to one hundred times more polluted than the air outside. Indoor air pollution is ranked by some as among the top five environmental risks to public health.

Health risks in residential dwellings due to airborne pollutants include, but are not limited to, those which aggravate allergies, intensify asthma and other respiratory ailments, and adversely circulate mold, fungi, pollen, bacteria, viruses, allergens, dirt, cooking fumes, tobacco smoke and emissions from candle burning. These problems tend to grow in magnitude in the tightly sealed and well-insulated modern day homes, where the same contaminated air is repeatedly circulated therein.

The harmful impact of airborne pollutants in residential dwellings is confirmed by the medical data found in various publications, i.e.: (1) at the present time most people spent 60% to 90% of their time indoors; (2) about 50% of all illnesses are either caused or aggravated by polluted indoor air; (3) the level of some hazardous nature of pollutants in indoor air is up to 70% times greater than pollutants in outdoor air; (4) two out of three indoor air quality problems involve, in some way, residential heating/air-conditioning systems; (5) more than 50 million Americans now suffer from airborne allergies; (6) at least one out of six people who suffer from allergies do so because of the direct relationship to fungi and bacteria in the air duct system in residential heating/air conditioning systems; (7) the number of Americans suffering from asthma has increased dramatically to over 12 million; (8) children and the elderly are especially affected by poor indoor air quality; and (9) standard commercial-available furnace filters, used in most homes, are less than 7% efficient in removing airborne contaminates.

The progressive build up of airborne pollutants in residential dwellings is due in large measure to inadequate health-based filtration in the homes. For decades, relatively thin fiberglass filter cartridges have been used at the air return intake duct to forced air furnaces, not to protect or alter air quality for those living in the residential dwelling, but to provide some level of protection for the furnaces. Restated, the standard fiberglass furnace filter used in household furnace/air conditioning systems was not designed for improving air quality for the occupants of residential dwellings.

Large industrial or commercial grade air filtration systems do not adapt well to household use without major retrofitting and the costs of purchase, installation and maintenance are prohibitive for the average homeowner.

Portable, free-standing single room air filtration devices have been proposed for home use but the effectiveness thereof for both the room where the device is operated and for the entire dwelling is relatively low.

### BRIEF SUMMARY AND OBJECTS OF THE PRESENT INVENTION

In brief summary, the present invention overcomes airborne problems of the past in residential dwellings by providing cost-effective and efficient filtration technology by which airborne pollution and contaminants are significantly removed initially and on an ongoing basis from air circulated and recirculated through HVAC (heating, ventilation and air conditioning systems).

Renovation, conversion, remodeling and retrofitting of the heating, ventilating and/or air conditioning systems in residential dwellings is not required, but only a simple exchange of a dual filter cartridge embodying one form of the present invention for the existing filter embodying the prior art. The present invention, for example, may comprise a frame or container sized to fit in the existing filter slot at the air return intake of a forced air furnace. No retrofitting of any type is required. The frame or container carries a dual filter comprising both an anti-microbial Ultra-Violet (UV) lamp, for irradiation of airborne viruses and bacteria, among other things, and an electrostatic filter pad for trapping and holding other airborne particles, some of which may be microscopic in size.

With the foregoing in mind, it is a primary object of the present invention to overcome air filtration problems of the past in residential dwellings.

Another valuable object is the provision of novel air filtration technology, including dual filters and methodology, for cost-effective and efficient filtration by which airborne pollutants and contaminants are significantly eradicated from air circulated and recirculated through forced air furnaces, ventilation systems and/or air-conditioners in residential dwellings.

A further paramount object is to provide for a non-complex filtration technology, including dual filters and methods, by which ineffective household furnace, ventilating systems and/or air-conditioning air filters are replaced by highly effective filters of this invention such that renovation, conversion, remodeling and/or retrofitting of the heating, ventilating and/or air-conditioning systems in the residential dwelling is not required, only an easy exchange of filters embodying the present invention for filters embodying the prior art.

A further important object is the provision of a compact household dual filter cartridge to replace a prior furnace, ventilation and/or air conditioning air filter to the end that health problems due to airborne maladies are significantly reduced.

An additional object of significant is the provision of dual air filters sized and shaped to simply replace pre-existing air filters, without retrofitting of the air system of a residential dwelling or any part thereof.

A further paramount object is to provide a dual air filter for a residential dwelling which emits anti-microbial ultra-violet radiation to attack airborne viruses and bacteria, among other things, and electrostatically filters other airborne particulates whereby the residents are subjected to fewer health risks because airborne pollutants and contaminates are significantly reduced.

These and other objects and features of the present invention will be apparent from the detailed description taken with reference to accompanying drawings.

### BRIEF DESCRIPTION OF THE DRAWINGS

FIG. 1 is a block diagram illustrating one form of the present invention;

FIG. 2 is an enlarged perspective of the dual filter of FIG. 1 retained in a rigid frame;

FIG. 3 is an enlarged cross section taken along lines 3-3 of FIG. 6;

FIG. 4 is an enlarged cross section taken along lines 4-4 of FIG. 6;

FIG. 5 is an enlarged cross section taken along lines 5-5 of FIG. 2;

FIG. 6 is an exploded perspective of the dual filter of FIG. 2;

FIG. 7 is an enlarged fragmentary cross section taken along lines 7-7 of FIG. 6;

FIG. 8 is a diagram of the details of the ultra violet lamp of the dual filter of FIG. 2;

FIG. 9 is a perspective of a dual filter according to the present invention retained in a cardboard or plastic retainer; and

FIG. 10 is a fragmentary cross section taken along lines 10-10 of FIG. 9.

### DETAILED DESCRIPTION OF THE ILLUSTRATED EMBODIMENTS

The present invention addresses and solves or substantially elevates long-standing airborne health problems in residential dwellings. Unique dual purpose air filtration technology for residential HVAC (heating, ventilation and air conditioning) systems comprising anti-microbial and anti-particulate substitute filters and related methodology, according to the principles of the present invention, provide remarkable improvement in the quality of air in residential dwellings on a cost-effective basis. Retrofitting of the air displacement system in the residential dwelling is not mandated. Thus, health-related problems of an airborne nature through the entire dwelling are significantly reduced on the first pass of air through the substitute filter and even more so with subsequent passes.

Typically, the prior filter in the air system, for example, at the influent to a forced air furnace or air conditioning system, is manually removed from its operative position. Thereafter, the substitute dual filter according to the present invention, having essentially the same dimensions, is manually inserted in the same operative position as the prior filter. No technical training is required.

While other shapes and forms of the invention may be utilized, the dual filter may comprise a cartridge comprising a flat retainer comprising a peripheral frame or container comprised of plastic or cardboard or other suitable material carries, in combination, both an electrostatic porous filter pad, which may be electrostatically charged by air flow therethrough, to remove particulate airborne particles, which may be so small as to be invisible to the human eye, and an ultra violet emitter, which irradiates airborne bacteria and viruses, among other things. The airborne particles and microbes so treated emanate from a variety of sources including, but not limited to, dust on the floors or other surfaces that are distributed by all activities in your house including the air circulation by your furnace blower. Particles sometimes enter the home as dirt, from cooking foods, from smoke and smoking and by burning candles. Also hair and skin flakes from humans or pets sometime become airborne. It is commonplace to find very harmful airborne contaminates in the home, such as pollen, bacteria, viruses and certain gases. These gases may comprise nitrous oxides, carbon monoxide, hydrogen cyanide, and tobacco-derived formaldehyde, acrolein and benzene, among others. These problems are further aggravated because today's homes are often tightly sealed and insulated to conserve energy, so that certain of the harmful airborne contaminates not only multiply, but are circulated and repeatedly recirculated throughout the entire residential dwelling.

By combining the bacteria-killing power of ultra violet light in the return air duct along with the filtration capabilities of an electrostatic filter pad, a very high percentage of all bacteria, mold and allergens within the residential dwelling are contained and killed usually on the first pass of air through the dual purpose filter. The electrostatic filter pad traps all or nearly all airborne particles, captured in some embodiments down to 0.25 microns, which are the particles most likely to be inhaled and to cause health problems.

While other configurations can be used, the preferred dual filter comprises one simple integrated unit which fits into the existing one-inch furnace filter slot. There is no expensive cutting or modification of existing ductwork. The existing filter is manually removed and a dual purpose filter of this invention is inserted in its place and then plugged into any household 110 volt electrical outlet. This air purification technology does not emit harmful Ozone.

Filters of this invention also reduce or eliminate odors in the residential dwelling caused by mold, pets, smokers, cooking odors, among other things, because the sources of odor are reduced or eliminated.

Unlike conventional filter cartridges, which must be removed, discarded and replaced at regular intervals, filters of the present invention may be of a permanent nature, requiring only that the electrostatic filter pad be cleansed on occasions.

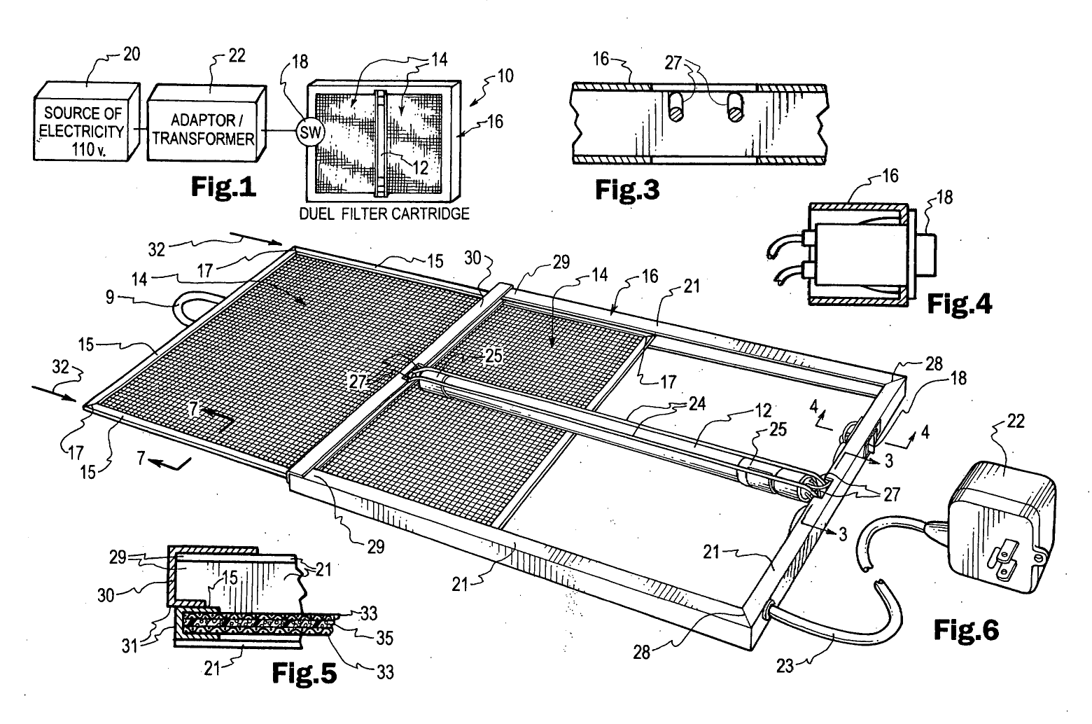

Reference is now made to the drawings, wherein like numerals are used to designate like parts throughout. FIG. 1 illustrates a dual filter 10, embodying principles in accordance with the present invention, comprises at least one ultra violet (UV) lamp 12 and an electrostatic filter pad 14 (included filter frame 15 with mitered comers 17). The filter frame 15 essentially duplicates frames used for window screens. A looped tether 9, used to pull filter 14 and frame 16, is connected to the frame 15 by forcing the two ends of the tether 9 between the frame 15 and the filter pad 14. Both the UV lamp 12 and the electrostatic filter pad 14 are carried by a retainer, generally designed 16, illustrated as comprising a peripheral frame extending around the perimeter of the dual filter 10.

The ultra violet lamp 12 receives power through a switch 18, when on. Power is obtained from a conventional household 110 voltage outlet 20, transformed at adapter/transfer 22 into 22 watts, 62 volts and about 0.4 amps electrical power, delivered by electric cord 23 the ultra violet lamp 12 to illuminated lamp 12 when switch 18 is on. See FIG. 1.

While any suitable anti-pathogenic source of ultra violet radiation may be used to comprise lamp 12, a high energy UV-C germicidal light is preferred because of its capability of sterilizing and killing a very high percentage, if not all, airborne bacteria and viruses, among other things, passing through the filter 10. The optimum germicidal wave-length of UV-C radiation is about 254 nanometers, which falls within the UV-C spectrum.

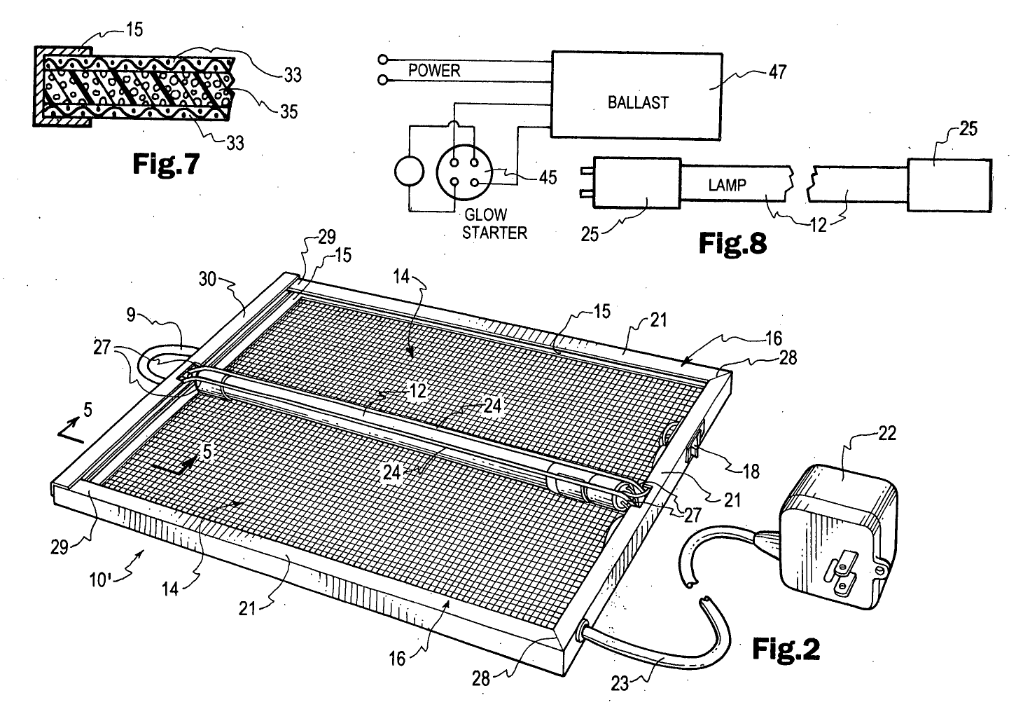

The ultra-violet emitter 12 is illustrated in FIGS. 2 and 5 as being retained and supported in position by pair spaced rods 24, formed of a rigid material, which may be stainless steel. Each rod 24 is connected to an associated metal end piece 25 of the lamp 12. Each rod 24 comprises two dog-legged prongs 27, which are free of the frame 16 but are forced against the frame 16 to stabilize the lamp 12 when the electrostatic filter pad is tightly inserted into the frame 16. Compare FIGS. 2 and 6.

The frame 16 of the dual filter 10 is illustrated in FIGS. 2 and 5 and comprises, as illustrated, three U-shaped sides or legs 21 formed from a single length of channel comprised of stainless steel or other suitable material, notched and joined together to form two mitered comers 28 and two ends 29. A fourth leg 30, best shown in FIG. 5, spans between and is connected, as by welding to ends 29. Leg 30 comprises somewhat of an L-shaped configuration with a width about two-thirds the width of legs 21, thereby defining a slot 31 through which the multi-layer electrostatic filter pad 14 and frame 15 are unitarily slidably inserted as indicated by arrows 32 in FIG. 6. The pad 14 and frame 15 are sized and shaped to occupy essentially all of the internal area defined by frame 16.

While other electrostatic filter materials may be used, it is presently preferred that a MERV-8 rated material comprising two outside one-quarter inch layers 33 of porous BHC (black huckaback) and an intermediate one-quarter inch layer of non-woven porous polyester 35 be used because of the ability thereof to trap particles as small as 0.25 microns. MERV is an acronym for “minimum efficiency reporting value.”

It is preferred for most installations in residential dwellings that frame 16 per se and the remainder of the dual filter 10 collectively have a thickness on the order of one inch. This accommodates removal of the previously installed conventional filter cartridge and the insertion of dual filter cartridge 10 within the existing one-inch filter furnace slot, thereby avoiding any requirement to retrofit ductwork, ventilation facilities, air-conditioning systems and/or forced-air furnaces. Once placed in the pre-existing one-inch furnace slot, the adapter/transformer 22 is merely plugged into a household 110 volt outlet and the switch 18 manually placed in its “on” state.

When the furnace, for example, is turned “on” by the thermostat in the residential dwelling, the LW lamp 12 is already in an “on” condition and, therefore, pathogenic and other microbes displaced by the squirrel cage fan of the furnace will kill and render impotent airborne viruses, bacteria and other things passing through the dual filter 10. The air displaced through the electrostatic filter pad 14 will charge the pad electrostatically and thus help cause airborne particles to become adhered to the pad 14. Accordingly, the effluent air from the filter 10 will have far less pollution and contaminants than the air influent to the filter 10. Furthermore, as the same air is repeatedly circulated through the residential dwelling and back through the forced-air furnace, additional cleansing takes place at the filter 10 so that over a period of time very few, if any, airborne pollutants and contaminants remain in the air contained within the residential dwelling.

It should be noted from FIG. 8 that the lamp 12 is equipped with a glow starter 45 and a ballast 47 by which the lamp is illuminated when switch 18 is placed in the “on” condition, utilizing electricity communicated from adapter/transformer 22.

The utilization of filters and filter cartridges in accordance with the present invention, as mentioned above, is effective in respect to all air contained within a residential dwelling, as opposed to prior attempts to purify the air in a single room, a most ineffective technique the costs of which approximating the cost of filter cartridges embodying the present invention.

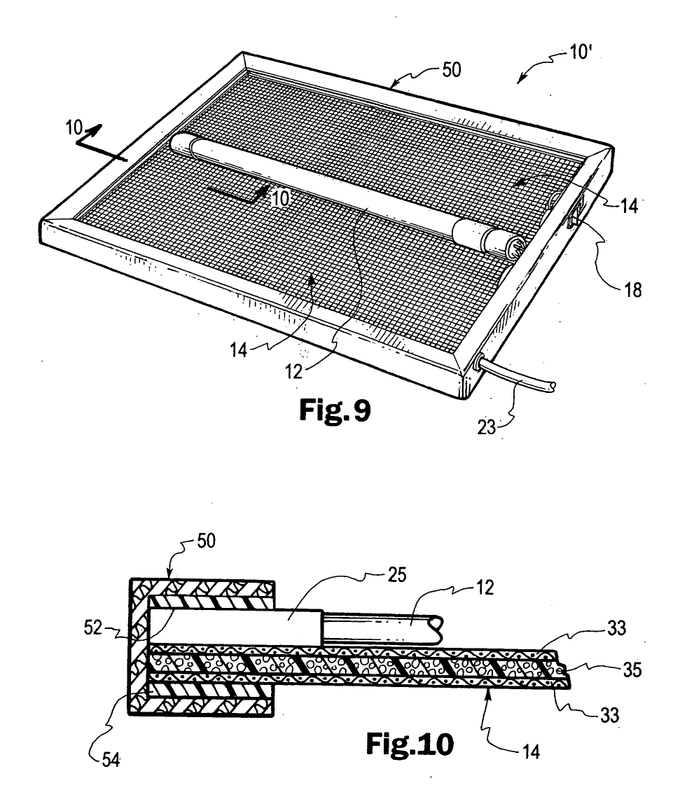

Reference is now made to FIGS. 9 and 10, which illustrates a further embodiment of the present invention, generally designated 10; differing from the embodiment of FIGS. 1-8 in that an inexpensive cardboard or plastic peripheral retainer, generally designated 50, is used to define the size of the filter 10′ and to retain and secure in appropriate positions the electrostatic pad 14 and the UV lamp 12. The dual filter 10′ comprises elements substantially the same as those described in conjunction with dual filter cartridge 10, but providing a lower cost.

The inexpensive cardboard or plastic peripheral edge retainer 50 is illustrated as comprising a U-shaped configuration, in cross section. See FIG. 10. The two ends 25 of the lamp 12 being secured to the peripheral frame by tape 52, having adhesive on both sides. The electrostatic filter pad 14 is identical to pad 14 of FIGS. 1-8, except the frame 15 has been removed and in lieu thereof tape 54, having adhesive on both sides, is interposed between the peripheral retainer 50 and one side of the electrostatic filter pad 14. The embodiment of FIGS. 9 and 10 comprises a less expensive version of the present invention sized to fit within the above-mentioned air duct receptacle comprising, typically, a one-inch slot.

The invention may be embodied in other specific forms without departing from the spirit of the central characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A method of exchanging filter cartridges in a return air system of a residential dwelling, comprising the acts of:
manually slidably removing an existing filter cartridge from a slot in the return air system;
manually slidably installing in the slot a replacement filter cartridge comprised of a source of ultra violet light and an electrostatic filter;
displacing residential air along the return air system and as influent air through the filter;
exposing the influent air to ultra violet radiation at the replacement filter cartridge whereby airborne infections are reduced;
trapping other airborne particles in the electrostatic filter of the replacement cartridge.

2. A filter cartridge for slot insertion into a return air system of a residential dwelling comprising:
a retainer limiting the filter cartridge to a planar configuration;
an ultra violet emitter carried by the retainer by which airborne contaminates in the return air including bacteria and viruses are reduced;
an electrostatic filter by which other airborne particles in the return air are captured.

3. A filter cartridge according to claim 2 wherein the ultra violet emitter comprises an element by which UV-C radiation is emitted.

4. A filter cartridge according to claim 2 wherein the electrostatic filter comprises at least one layer of porous black huckaback material.

5. A filter cartridge according to claim 2 wherein the retainer is selected from the group consisting of a peripheral frame and disposal container.

6. In combination:
a residential dwelling return air system comprising a duct through which influent air passes into a forced air furnace or an air conditioner;
a dual purpose filter within the duct, the filter comprising: (a) an electrostatic porous filter pad by which particulate matter carried by the return air is trapped; and (b) a source of ultra violet radiation by which airborne bacteria, viruses and other contaminates carried by the return air are irradicated.

7. A method of filtering return air in a residential dwelling, comprising the acts of:
displacing the return air through a composite filter;
irrating the return air passing through the filter with ultra violet radiation to kill airborne bacteria and viruses, among other things;
electrostatically capturing other airborne particles in an electrostatic filter pad of the composite filter.
